(19) United States
(12) Patent Application Publication
(10) Pub. No.: US 2021/0241263 A1
(43) Pub. Date: Aug. 5, 2021

(54) CREATING AND MANAGING BRANCH MOBILE WALLETS

(71) Applicant: Wells Fargo Bank, N.A., San Francisco, CA (US)

(72) Inventor: Joon Maeng, Newcastle, WA (US)

(21) Appl. No.: 14/984,409

(22) Filed: Dec. 30, 2015

(51) Int. Cl. G06Q 20/36; G06Q 20/40

(52) U.S. Cl. CPC G06Q 20/363; G06Q 20/401; G06Q 20/405

(57) ABSTRACT

Methods and systems for sending a branch mobile wallet to a recipient from a main mobile wallet of a user are disclosed. The main mobile wallet can operate on a mobile device and have one or more wallet items such as elements representing credit cards, debit cards, and merchant-specific cards. A request can be received to create a branch mobile wallet of the main mobile wallet and a one or more wallet items can be selected to include in the branch mobile wallet. Contact information can be received for the recipient of the branch mobile wallet. A request to send the branch mobile wallet to the recipient can be received and activation information can be sent to the recipient. The branch mobile wallet can be sent to the recipient after receiving a reply to the activation information.

### TECHNICAL FIELD

Embodiments described herein generally relate to mobile wallets and, for example and without limitation, mobile wallets that can create a branch wallet and send the branch wallet to a recipient.

### BACKGROUND

Mobile wallets can allow consumers to make contactless payments for products and services with mobile devices such as phones or watches instead of cash, credit cards or checks. Using an antenna in the mobile device, mobile wallets can communicate with contactless readers using near field communication (NFC). They can allow consumers to make secure payments in a relatively quick manner by placing their mobile devices near contactless readers at stores. Mobile wallets can also be used to make purchases within applications on mobile devices and over the internet.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which;

FIG. 1. illustrates a schematic diagram of a system, according to various examples;

FIG. 2 illustrates a method for sending a branch mobile wallet, according to various examples;

FIG. 3 illustrates a method for using a branch mobile wallet, according to various examples;

FIG. 4 illustrates a mobile device and user interface, according to various examples;

FIG. 5 illustrates a mobile device and user interface, according to various examples; and

FIG. 6 illustrates a swim diagram, according to various examples; and

FIG. 7 is a block diagram of a machine in the example form of a computer system within which a set of instructions, for causing the machine to perform any one or more of the methodologies discussed herein, may be executed.

### DETAILED DESCRIPTION

In various examples described herein, a wallet owner or user can send a branch of his or her main mobile wallet to a recipient. The branch mobile wallet can include selected elements of the main mobile wallet or can be a duplicate of the main mobile wallet. Branch mobile wallets can serve many useful purposes. For example, a company can issue a branch mobile wallet item to an employee for a trip. The branch mobile wallet can be a temporary branch wallet that can be deactivate at the end of the trip and reactivated for a subsequent trip. A branch mobile wallet and the main mobile wallet can be issued by the same entity or by different entities. In another example, a parent can send a branch mobile wallet to a child to pay a tuition or buy books. An individual can send a branch mobile wallet as a gift card or to make a payment to a friend. A sender can select a bank account as a branch mobile wallet item as a means of transferring money to the recipient. A wallet owner can also set rules governing use of a branch mobile wallet, for example, during creation of the branch wallet or thereafter.

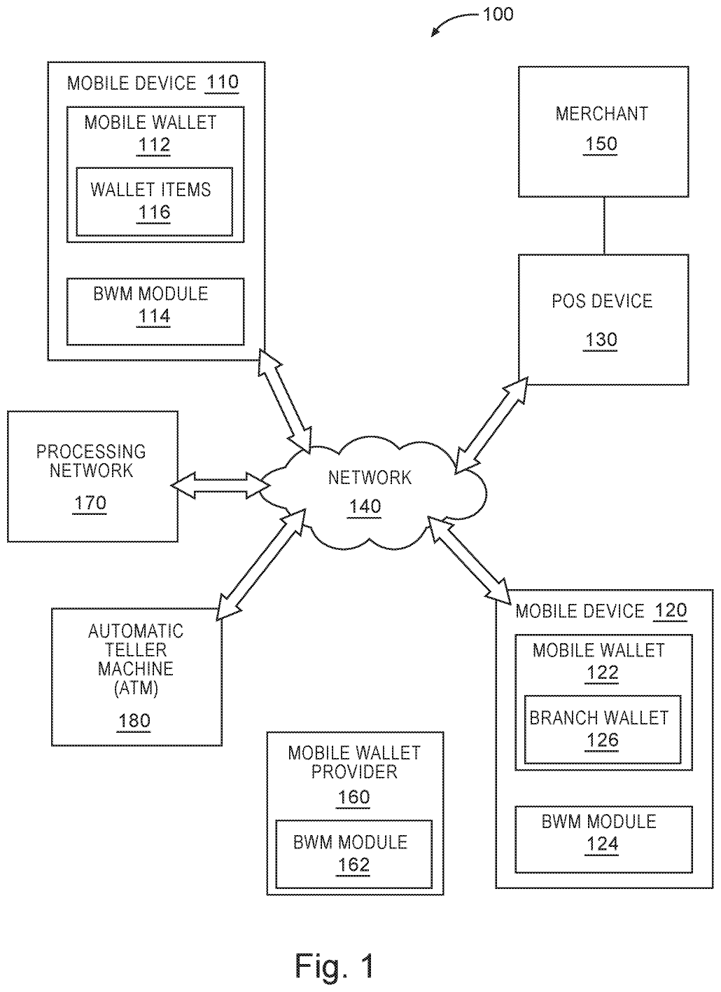

FIG. 1 illustrates an example environment 100 for mobile wallet transactions. The example environment includes a main mobile wallet application 112 (sometimes, simply referred to as a mobile wallet) operating on a mobile device 110 such as a smart phone or smart watch. The example environment 100 also includes a POS device or contactless terminal 130 associated with a merchant 150, a wallet service provider 160 and a processing network 170. The mobile wallet 112 can include one or more wallet items representing credit cards, debit cards, reward cards, identification cards, tickets, boarding passes, coupons etc. For each wallet item, the mobile device 110 stores unique account information. For a credit card, for example, the unique account information can be a unique token and cryptograph typically provided by the card network and/or card-issuing bank. In another example, the unique account information for a credit card can be the credit card number and the account holder's name.

The mobile wallet 112 can be used to make payments in a variety of ways including, as examples, at the contactless terminal 130 (e.g., point-of-sale (POS) card readers), through applications operating on the mobile device 110, and over the internet though websites. To make a payment at a merchant's store, for example, a user can select a wallet item (e.g., credit card item) for the transaction and place the mobile device 110 near the contactless terminal 130. The mobile device 110 can then wirelessly transfer unique account information (e.g., token and cryptograph) for the credit card to the contactless terminal 130 using near field communication (NFC) or magnetic secure transmission (MST), for example.

The mobile device 110 can also generate and send to the contactless terminal 130 a dynamic security code that is transaction specific. The contactless terminal 130 can send a merchant identification number, the unique account information (e.g., token and cryptograph) and transaction-specific dynamic security code, and the transaction amount to a processing network 170 (e.g., card network and issuing banks) to authorize payment. The user can also be requested by the mobile device 110 to authenticate the payment request by providing a fingerprint or entering a pin number or code.

The environment can further include one or more networks such as the network 140 over which the various systems communicate using network interfaces. The network 140 can include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 140 can include a single local area network (LAN) or wide-area network (WAN), or combinations of LAN's or WAN's, such as the Internet.

The mobile device 110 includes a branch wallet management (BWM) module 114 that enables a user of the main mobile wallet 112 to send a branch wallet 126 to a recipient's mobile device 120. The branch mobile wallet 126 can include one or more wallet items corresponding to wallet items 116 of the main wallet 112 or can be a duplicate of the main mobile wallet 112 including wallet items corresponding to all of the main wallet's items 116. The example system includes a wallet service provider 160 that interfaces with mobile devices 110, 120 to set up and manage mobile wallets including main wallets 112 and 122 and branch wallet 126. The wallet service provider 160 can be a card issuer or bank network of can be separate from those systems. One or both of the BWM modules 114, 124 can be a separate application from the respective mobile wallet application 111, 122 or can be an integral part of the respective mobile wallet application 111, 122.

In the illustrated system, the main wallet mobile device 110, the recipient device 120, and the wallet service provider 160 have branch wallet management (BWM) modules 114, 124 and 162, respectively, that allow main wallet users to establish and maintain branch wallets on recipient devices and allow recipient's to use the branch mobile wallets to make payments. The functionality of the BWM modules 114, 124, and 162 can vary depending on the application in order to carry out the processes described herein. For example, the BWM module 114 on the main wallet user device can be used to set up and request the creation of a branch mobile wallet and the wallet service provider BWM module 162 can create the branch mobile wallet, associate the branch mobile wallet with the user's main mobile wallet and notify the recipient BWM module 124 of the branch mobile wallet.

The branch mobile wallet 126 can be accessed by a recipient to make transactions. In other examples, the BWM modules 114, 124, and 162 can reside primarily on the wallet-service provider's system and the user's and recipient's devices can act primarily as client programs or inputs to the wallet-service provider's BWM module. In some examples, a BWM module can reside on a separate computing device such as a personal computer to allow, for example, set up, management, and use of branch mobile wallets from the personal computer. In an alternative environment, the mobile wallets 112, 122, the branch mobile wallet 126, and the BMW modules 114, 124 and 162 can reside in a cloud-based mobile wallet system and the mobile devices 110 and 120 can operate client applications that can access the functions of the cloud-based system remotely. Thus, branching of mobile wallets can be performed between mobile devices or virtual devices operating in the cloud.

The illustrated environment described above is provided by way of example as other types of mobile wallet architectures can be used with the systems described herein. For example, the mobile wallets, branch wallets and branch mobile wallet modules can operate on other types of computing devices such as desktop computers, laptop computers, and tablets and can further be distributed across one or more computing systems. The systems described herein work with a number of different wallet items as mentioned above. Each of the wallet items typically has an issuer. For example, a credit card is typically issued by a bank and managed by a card network and a ticket is typically issued by a ticketing agent. For ease of reading, the entity issuing a card or ticket or other wallet item for example is referred to as a card issuer.

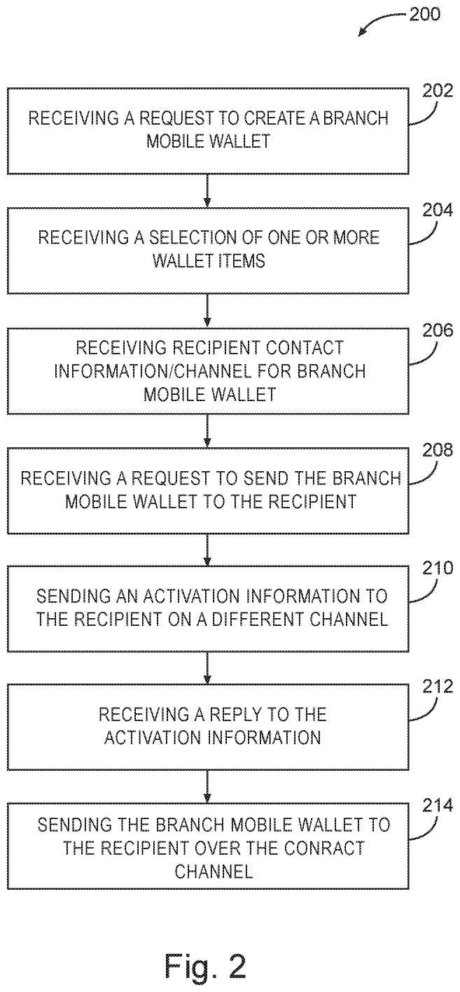

FIG. 2 illustrates a method 200 for sending a branch mobile wallet to a recipient from a main mobile wallet of a user. The main mobile wallet can, for example, be an application operating on a mobile device having one or more wallet items as discussed above. At 202, a BWM module can receive a request to create a branch mobile wallet of the main mobile wallet. The request can for example be received by a BWM module operating on a main wallet user's mobile device (e.g., through the user interface of the mobile device) or by a BWM module on a mobile wallet service provider which can receive the request from the main mobile wallet or another computing device having access to the main mobile wallet account.

At 204, a BWM module can receive a selection of one or more wallet items to include in the branch mobile wallet. For example, a main wallet user can open the main mobile wallet and select one or more of the wallet items in the main wallet using the user interface of the mobile device. This selection can be done at the time the branch wallet is first set up or after set up a user can add and remove wallet items. At the time of set up of a branch wallet or thereafter, a main wallet user can also set rules governing the use of the branch wallet or individual wallet items as will be discussed further below.

At 206, a BWM module can receive, from a main wallet user, contact information for the recipient of the branch mobile wallet. This can, for example, include the name of the recipient and a contact channel such as an email address or phone number. At 208, a BWM module can receive a request from the user to send the branch mobile wallet to the recipient. For example, after selecting wallet items, setting rules for the items and/or the branch wallet and providing recipient contact information, the user can request the BWM module to send the branch wallet to the recipient. Like block 202, with blocks 204, 206 and 208, the information and requests can for example be received by a BWM module operating on the main wallet user's mobile device or by a BWM module on a mobile wallet service provider which can receive the selection from the main mobile wallet or another computing device having access to the main mobile wallet account.

At 210, after receiving the request from the user to send the branch wallet, a BWM module can, for example, send activation information to the recipient prior to sending the branch mobile wallet. The activation information can, for example, be text or email message that the recipient can reply to or which contains a hyperlink that can be selected by a recipient. In other examples, the activation information can be a code that the recipient can enter in the recipient's main wallet application operating on the recipient's mobile device. The activation information can be sent by a BWM module operating on the wallet service provider or in other examples can be sent by a BWM module on the user device.

A BWM module (e.g., on the wallet service provider or user device) can further, for example, determine a different channel for sending the activation information than the contact channel for the recipient. This can involve the user providing to the mobile application/provider a second contact channel for the recipient. For example, if the contact channel is an email, the mobile application/provider can receive a cell phone number from the recipient for sending activation information. In other example, the mobile application/provider can query a database of mobile wallet owners to determine if the recipient already has established a mobile wallet and retrieve from the database contact channel information for the recipient (e.g., email address, cell phone, mobile wallet address etc.)

At 212 and 214, a BWM module (e.g., on the wallet service provider or user device) can receive a reply to the activation information from the recipient (212) and establish the branch mobile wallet on the recipient's mobile device after receiving the reply (214). The branch mobile wallet can be established as a wallet within the recipient's main mobile wallet or can be established as a separate wallet. The method can further include determining if the recipient has a mobile wallet application prior to establishing the branch mobile wallet and based on the determination automatically, or upon the recipient's request downloading, a mobile wallet application to the recipient's mobile device. In one embodiment, the BWM module loans mobile wallet items to the branch mobile wallet. For example, the BWM module can disable a main mobile wallet or wallet item that is sent to and accepted by a recipient as a branch wallet or item.

As part of establishing the branch mobile wallet, a BWM module (e.g., on the wallet service provider) can send to the recipient's mobile device the same unique account information for each mobile wallet item as on the main mobile wallet or can send different, unique account information for the branch mobile wallet items. In the latter case, for each wallet item, a BWM module (e.g., on the wallet service provider) can maintain a database associating the main wallet item's and branch wallet item's unique account information with one another. For example, with a credit card, the BWM module at a wallet service provider can provide a different, unique token and cryptograph to the branch wallet device (e.g., a token and cryptograph that is different than the ones provided to the main wallet device), and can store data in a database associating the two unique tokens and cryptographs with one another with and with the account associated with the credit card.

In some examples, prior to sending the branch mobile wallet, a BWM module (e.g., on the wallet service provider) can send a message to the recipient, allowing the recipient to accept or decline the branch wallet or to review the mobile wallet before accepting it. The message can be sent over the contact channel (e.g., by email, text, or inter-application directly to a recipient's mobile wallet application). The BWM module can receive the recipient's selection and act accordingly and report the recipients response (e.g., decline or accept, or under review) to the user. In this example, upon receiving an acceptance, the branch mobile wallet can then be sent.

Once established, a branch mobile wallet or individual wallet items within the branch wallet can be deactivated in a number of manners. For example, a user can set a branch wallet or item as temporary and can provide a period of time during which the branch wallet or item can be used. The BWM module can determine if the period of time has elapsed (e.g., periodically or prior to a transaction request) and, if so, deactivate the branch mobile wallet or item. For example, a user can set a branch wallet or item as being for one one-time use and the BWM module can deactivate the branch mobile wallet or item after a transaction that uses the branch wallet or item. These settings can be received by a BWM module from the user during set up of the branch wallet or thereafter. The branch mobile wallet can, for example, also be deactivated after receiving a deactivation request from the main wallet user that authorized the creation of the branch mobile wallet.

A BWM module can deactivate a branch mobile wallet in a number of ways. For example, a BWM module can store a data field in a database entry for the branch mobile wallet which can reflect a closed status or active status and can update the data field to a closed status to deactivate the account. This can, for example, provide a convenient way for a main wallet user to reactivate deactivated branch wallets which can be useful in many environments (e.g., an employer can activate and deactivate branch wallets for employees that travel). Upon deactivation, the branch wallet can no longer be accessed by the recipient on his or her mobile device. In addition, in some examples, the BWM module can also delete some or all of the unique account information (e.g., token and/or cryptograph) stored on the recipient's mobile device.

After, or in the process of establishing the branch mobile wallet, a BWM module (e.g., on the wallet service provider) can establish a communication channel between the main wallet user's mobile device and the recipient's mobile device such as an instant messaging or chat line.

As mentioned above, a BWM module (e.g., on the wallet service provider or on the user device) can receive from a main wallet user one or more rules related to the use of the branch mobile wallet or one or more wallet items in the branch wallet. For example, it can receive rules specifying the duration of the branch mobile wallet or items, the amount of funds that can be spent using the branch mobile wallet or items, the geographic location of use of the branch mobile wallet or wallet items, the types of goods or services that can be purchased using the branch mobile wallet or wallet items, and the need for prior authorization of the branch wallet or wallet items. A main wallet user can set these rules at any time including during set up of the branch mobile wallet or thereafter.

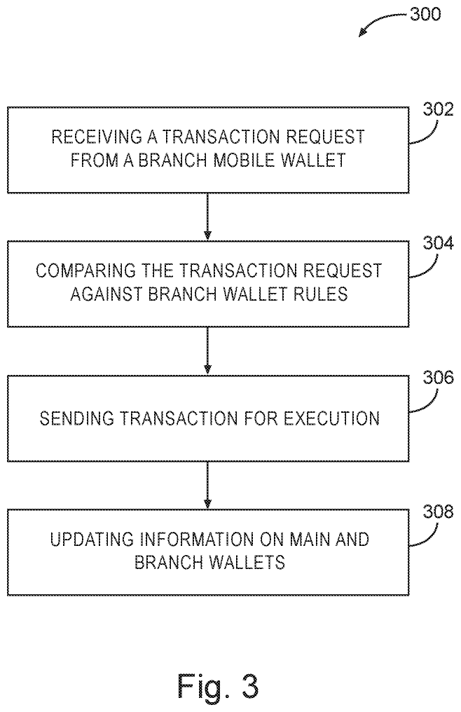

FIG. 3 illustrates an example method 300 of using a branch mobile wallet. At block 302, a branch mobile wallet receives a request to make a transaction using a particular wallet item in the branch mobile wallet. For example, at a POS card reader, the branch wallet user can open his or her branch wallet and select a wallet item for making a transaction and initiate a transaction by tapping or waving the mobile device at the card reader. The branch wallet mobile device can send a unique account information (e.g., token and cryptograph) associated with selected mobile wallet item in some cases along with a transaction-specific security code to the card reader, which can then send this and other requisite information along bank network and issuing banks for payment authorization.

At 304, a BWM module can compare the transaction to one or more rules established by the main mobile wallet user (e.g., transaction limits, types of goods that can be purchased, etc.) and can deny the requested transaction or approve the transaction based on the comparison. In some examples, the branch wallet mobile device sends unique account information for a transaction after a BWM module checks the transaction against one or more rules. The BWM module can further report the transaction request to the user and receive authorization from the user prior to approving the payment. At 306, upon approval based on the user rule set, the BWM module can send the transaction to a bank or bank network for processing and payment authorization.

At 308, the BWM module can update information on the main mobile wallet and the branch mobile wallet based on executed transactions and other changes to wallet items. For example, if a user/owner of a main wallet updates balances, balance limits or rules related to one or more of the wallet items, the BWM module can update the information in the branch mobile wallet. Managing the branch mobile wallet can also include updating new credit card info—zip codes, new balance limits, new rules established by user, and any other changes to main mobile wallet that impact branch mobile wallet.

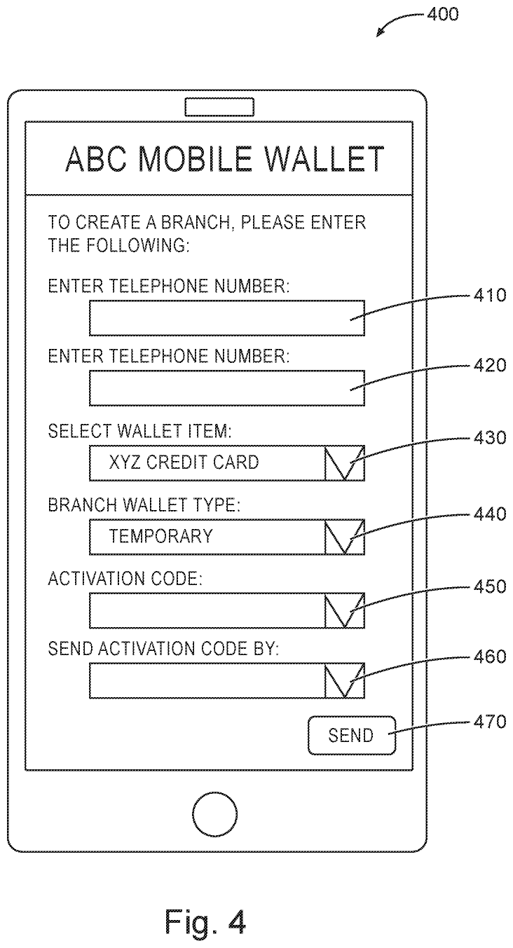

FIG. 4 illustrates an embodiment of a user interface 400 displayed by a BWM module of a mobile wallet according to an example. Although a specific user interface design is presented, other arrangements of user interface elements may be used without departing from the scope of this disclosure. The illustrated mobile wallet user interface 400 allows a mobile wallet owner (e.g., sender) to create and send a branch of the mobile wallet to a recipient. The sender can, for example, enter a telephone number 410, 420 of the recipient of branch mobile wallet twice to make sure that the recipient phone number is correct. The sender can choose one or more wallet items 430 (e.g., XYZ credit card) or the mobile wallet itself to send as the branch mobile wallet, and can enter the type of branch mobile wallet in line 430.

The type of branch mobile wallet can, for example, be one-time use, temporary, or remote deactivation. If the type is one-time, for example, the recipient of branch mobile wallet can use the branch mobile wallet once and the BWM module can automatically deactivate the branch wallet after its use. If the sender selects temporary, the BWM module can, for example, open a window and request the user to enter a termination time and date. The temporary branch can be deactivated automatically at the termination time and date. If the sender selects remote deactivation, the sender can instruct the BWM module to deactivate the branch mobile wallet permanently or temporarily from the main mobile wallet at any time.

At 450 and 460, the sender can also, for example, specify an activation code of the branch mobile wallet and specify a media or channel over which the BMS module can send the activation code. The activation code can be delivered to the recipient in a separate channel from the notification. For instance, if the BWM module notified the recipient of the mobile wallet branch by email, the BWM module can send the activation code by SMS message. In other examples, the BWM module can send a message to the recipient of the branch mobile wallet to make a call to obtain the activation code. In other example, the BWM module (e.g., operating on the wallet service provider) and generate the activation code and the media to send the code. After entering the information into user interface 400, the sender can activate (e.g., click, touch) the send button 470 to send a branch mobile wallet to the recipient.

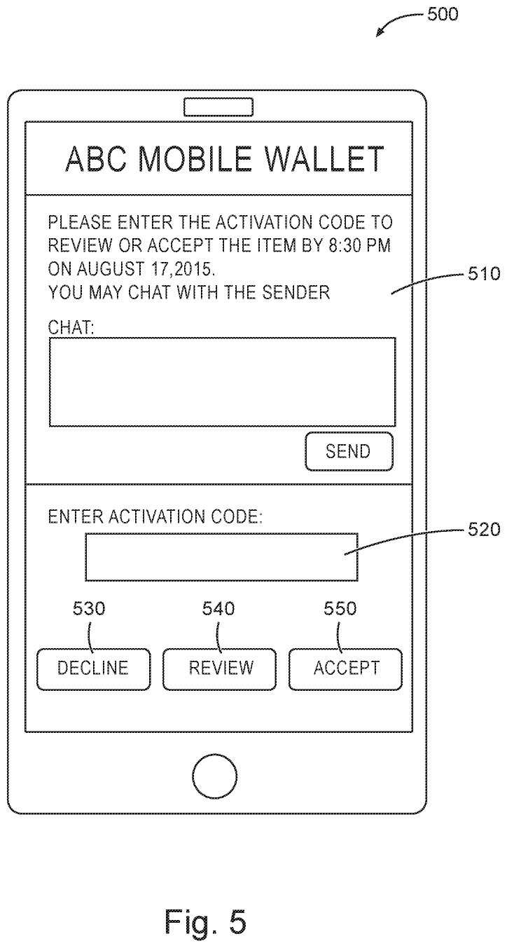

FIG. 5 illustrates an embodiment of a user interface presented by a BWM module on a recipient mobile device (e.g., to accept a branch mobile wallet). Although a specific user interface design is presented, other arrangements of user interface elements may be used without departing from the scope of this disclosure. The BWM module can receive a hyperlink via email or text message with a notification of a branch mobile wallet from a sender device, for example. When the recipient clicks the hyperlink in the email or text message, the BWM module can present the user interface 500 on the recipient's mobile phone. The user interface 500 can, for example, include a delivery message with a chat (e.g., instant message) window 510, a box to enter the activation code 520, and buttons that the user can select to decline 530, review 540, and accept 550 the branch mobile wallet. The recipient can chat with the sender via the chat window and ask questions or request to change conditions on the branch mobile wallet. The mobile wallet provider can facilitate the chat/messaging between the sender and the recipient. To accept or review the branch mobile wallet, the recipient can in some examples be requested to enter the activation code (e.g., in the box 520).

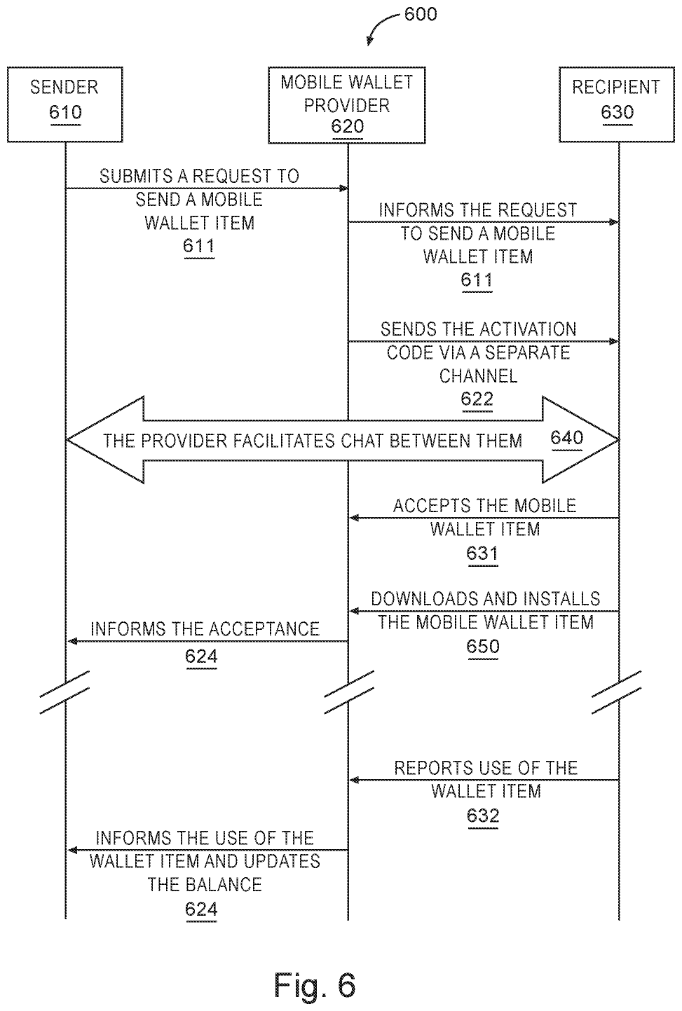

FIG. 6 illustrates a diagram of interaction between a sender of a branch mobile wallet 610, a mobile wallet provider 620, and a recipient of the branch mobile wallet 630, in accordance with an example embodiment. The sender 610 can enter information to create a branch mobile wallet (e.g., using an interface such as that illustrated in FIG. 4) and submit a request to send the branch mobile wallet item(s) to the mobile wallet provider 620 as illustrated at 611. The mobile wallet provider 620 can notify the recipient 630 of the branch mobile wallet as illustrated at 621. The mobile wallet provider 620 can, for example, also send an activation code via a separate channel from the notification channel as illustrated at 622. The mobile wallet provider 620 can also facilitate a chat session between the sender 610 and the recipient 630 as illustrated at 640. The recipient can provide the activation code and accept the branch mobile wallet item(s) (e.g., using an interface such as that illustrated in FIG. 5) as illustrated at 631.

At 650, the recipient 630 can download a mobile wallet application program from the mobile wallet provider or a third party and include the branch mobile wallet item in the recipient's mobile wallet as illustrated at step 650. If the recipient already has a mobile wallet (e.g., issued by the mobile wallet provider) operating on recipient's device, the branch mobile wallet item can be added to the existing mobile wallet. The mobile wallet provider can inform the sender 610 of the recipient's acceptance of the branch mobile wallet as illustrated at 623. When the recipient uses the branch mobile wallet item, the branch mobile wallet can, for example, report the use of the branch wallet to the mobile wallet provider 620 as illustrated at 632. The mobile wallet provider can, for example, inform the recipient's main mobile wallet of the use of the branch mobile wallet and can update the balances of the branch mobile wallet elements as illustrated at 624. In other embodiments, the branch mobile wallet can directly report its use to the main mobile wallet.

When a main mobile wallet creates a branch mobile wallet, the mobile wallet provider can consider both of them under one account or can create two accounts and establish a link between them. In one embodiment, prior to a transaction request being processed, the sender (e.g., through his or her main mobile wallet) can approve the use of the branch mobile wallet each time the branch mobile wallet submits a payment.

In other embodiment, the sender can send the branch mobile wallet with other limitation such as geographic area, time of use, items to purchase, and/or maximum amount to spend one item or total. The branch mobile wallet can produce an alarm or warning if it violates the limitation imposed by the main mobile wallet.

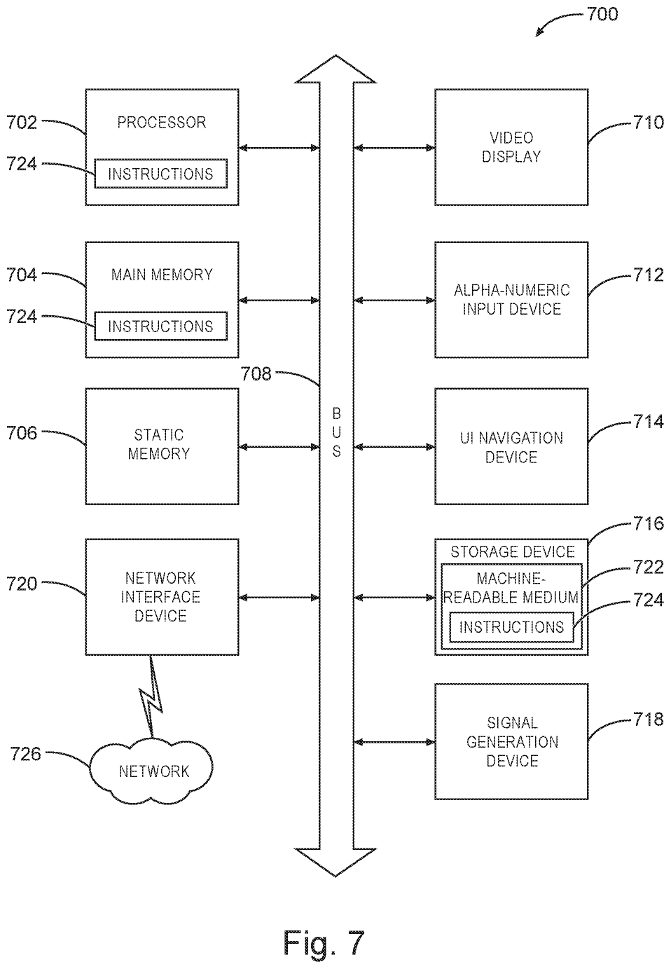

FIG. 7 is a block diagram illustrating a machine in the example form of a computer system 700, within which a set or sequence of instructions can be executed to cause the machine to perform any one of the methodologies discussed herein, according to an example embodiment. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 can further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 can additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 can also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” can include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 can further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for sending a branch mobile wallet to a recipient from a main mobile wallet of a user, the main mobile wallet operating on a mobile device, the method comprising:
receiving, via at least one processor, a request to create a branch mobile wallet of the main mobile wallet, the main mobile wallet having one or more wallet items;
receiving, via the at least one processor, a selection of one or more wallet items from the main mobile wallet to include in the branch mobile wallet;
receiving, via the at least one processor, contact information associated with a contact channel for the recipient of the branch mobile wallet, wherein the contact channel for the recipient is based on contact channel information for a previously established mobile wallet for the recipient;
receiving, via the at least one processor, a request to send the branch mobile wallet to the recipient;
determining the recipient does not have a mobile wallet application for the branch mobile wallet;
in response determining the recipient does not have the mobile wallet application, sending a request to the recipient to download the mobile wallet application;
establishing a communication channel between the main mobile wallet residing on the mobile device and a mobile wallet residing on a recipient device;
after receiving the request, directly sending, via the at least one processor, activation information to the recipient over the communication channel that is different than the contact channel;
receiving, via the at least one processor, a reply that includes the activation information from the recipient;
establishing, via the at least one processor, the branch mobile wallet on the recipient device with a plurality of wallet items, based on the selection of one or more wallet items, after receiving the reply to the activation information; and
transmitting a command to disable a wallet item of the plurality of wallet items at the branch mobile wallet on the recipient device.

2. The method of claim 1, further including deactivating the branch mobile wallet after a payment, after a period of time has elapsed or after receiving a deactivation request from the user.

3. The method of claim 1, further including receiving a selection of a type of the branch mobile wallet, the selection being one or more of temporary, one-time, or remotely deactivated.

4. The method of claim 1, further including receiving a selection from the recipient to accept, decline or review the branch mobile wallet prior to sending the branch mobile wallet to the recipient.

5. The method of claim 1, further including managing the branch mobile wallet including updating information, balances, balance limits, or rules related to one or more of the wallet items.

6. (canceled)

7. (canceled)

8. The method of claim 1, further including establishing a recipient main mobile wallet using the mobile wallet application and establishing the branch mobile wallet within the recipient main mobile wallet.

9. The method of claim 1, further including receiving one or more rules related to a use of the one or more wallet items in the branch mobile wallet, the rules specifying one or more of duration of the branch mobile wallet, an amount of funds that can be spent using the branch mobile wallet, a geographic location of use of the branch mobile wallet, types of items that can be purchased using the branch mobile wallet, and a need for prior authorization.

10. The method of claim 9, further including receiving a request to make a payment using a particular wallet item in the branch mobile wallet, determining whether the payment can be made using the one or more rules, and after the determination, making the payment and reporting the payment to the user.

11. The method of claim 10, further including reporting the request to the user and receiving authorization from the user prior to making the payment.

12. A non-transitory computer-readable storage medium, the computer-readable storage medium including instructions that when executed by a computer, cause the computer to perform operations of:
receiving a request to create a branch mobile wallet of a main mobile wallet of a user, the main mobile wallet having one or more wallet items;
receiving a selection of one or more wallet items from the main mobile wallet to include in the branch mobile wallet;
receiving contact information associated with a contact channel for a recipient of the branch mobile wallet, wherein the contact channel for the recipient is based on contact channel information for a previously established mobile wallet for the recipient;
receiving a request to send the branch mobile wallet to the recipient;
determining the recipient does not have a mobile wallet application for the branch mobile wallet;
in response determining the recipient does not have the mobile wallet application, sending a request to the recipient to download the mobile wallet application;
establishing a communication channel between the main mobile wallet residing on a mobile device and a mobile wallet residing on a recipient device;
after receiving the request, directly sending activation information to the recipient over the communication channel that is different than the contact channel;
receiving a reply that includes the activation information from the recipient;
establishing the branch mobile wallet on the recipient device with a plurality of wallet items, based on the selection of one or more wallet items, after receiving the reply to the activation information; and
transmitting a command to disable a wallet item of the plurality of wallet items at the branch mobile wallet on the recipient device.

13. The medium of claim 12, wherein the instructions cause the computer to perform operations of deactivating the branch mobile wallet after a payment, after a period of time has elapsed or after receiving a deactivation request from the user.

14. The medium of claim 12, wherein the instructions cause the computer to perform operations of receiving a selection of a type of the branch mobile wallet, the selection being one or more of temporary, one-time or remotely deactivated.

15. A system comprising:
at least one processor; and
at least one memory storing instructions that, when executed by the at least one processor, configure the at least one processor to:
receive a request to create a branch mobile wallet of a main mobile wallet of a user, the main mobile wallet having one or more wallet items;
receive a selection of one or more wallet items from the main mobile wallet to include in the branch mobile wallet;
receive contact information associated with a contact channel for a recipient of the branch mobile wallet, wherein the contact channel for the recipient is based on contact channel information for a previously established mobile wallet for the recipient;
receive a request to send the branch mobile wallet to the recipient;
determine the recipient does not have a mobile wallet application for the branch mobile wallet;
in response determining the recipient does not have the mobile wallet application, send a request to the recipient to download the mobile wallet application;
establishing a communication channel between the main mobile wallet residing on the system and a mobile wallet residing on a recipient device;
after receiving the request, directly send activation information to the recipient over the communication channel that is different than the contact channel;
receive a reply that includes the activation information from the recipient;
establish the branch mobile wallet on the recipient device with a plurality of wallet items, based on the selection of one or more wallet items, after receiving the reply to the activation information; and
transmit a command to disable a wallet item of the plurality of wallet items at the branch mobile wallet on the recipient device.

16. The system of claim 15, wherein the at least one processor is configured to manage the branch mobile wallet including updating information, balances, balance limits, or rules related to one or more of the wallet items.

17. The system of claim 16, wherein the at least one processor is configured to receive one or more rules specifying one or more of duration of the branch mobile wallet, an amount of funds that can be spent using the branch mobile wallet, a geographic location of use of the branch mobile wallet, types of items that can be purchased using the branch mobile wallet, and a need for prior authorization.

18. The system of claim 17, wherein the at least one processor is configured to receive a request to make a payment using a particular wallet item in the branch mobile wallet, determine whether the payment can be made using the one or more rules, and after the determination, make the payment and reporting the payment to the user.

19. The system of claim 18, wherein the at least one processor is configured to report the request to the user and receive authorization from the user prior to making the payment.

20. (canceled)

21. The medium of claim 12, wherein the instructions cause the computer to perform operations of establishing a recipient main mobile wallet using the mobile wallet application and establishing the branch mobile wallet within the recipient main mobile wallet.

22. The system of claim 15, wherein the at least one processor is configured to establish a recipient main mobile wallet using the mobile wallet application and establish the branch mobile wallet within the recipient main mobile wallet.
